(19) United States
(12) Patent Application Publication
(10) Pub. No.: US 2016/0040608 A1
(43) Pub. Date: Feb. 11, 2016

(54) Internal Combustion Engine Fuelling

(71) Applicant: TCK ENGINES LTD, Liverpool Merseyside (GB)

(72) Inventor: Stephen Richard Terry, Liverpool Merseyside (GB)

(21) Appl. No.: 14/438,615

(22) PCT Filed: Feb. 11, 2013
(86) PCT No.: PCT/GB2013/050301

§ 371 Date: Apr. 25, 2015

(30) Foreign Application Priority Data
Oct. 29, 2012 (GB) 1219338.9

(51) Int. Cl. F02D 19/06; F02D 41/00

(52) U.S. Cl. CPC F02D 19/061; F02D 41/0025

(57) ABSTRACT

This invention is concerned with improving the fuel efficiency of an engine. An engine or method of operating an engine that by introducing a secondary additive fuel or fuels in order to effect within the engine an extended combustion time and improve the ‘burn’ during the power stroke so as to ensure that fuel is utilised (burnt) as fully as possible thus improving the efficiency of the engine and bringing about a reduction of harmful exhaust emissions.

This invention relates to improvements in and relating to combustion engines, and in particular, to improvements in the combustion efficiency of internal combustion engines.

Conventional internal combustion engines comprise a piston that reciprocates within a cylinder and a crank mechanism for converting the reciprocating movement of the piston into a rotational output for useful work. The operation and efficiency of an internal combustion engine depends on a great number of factors, including the type and mixture of fuel used, the compression ratio, the dimensions of the piston/cylinder, etc.

One of the main factors, however, that determines the overall efficiency of the engine is the manner in which the fuel is burned, that is to say, the speed and completeness of the burn. Combustion occurs during the ‘power’ stroke of the piston which has a fixed length and profile. For 100% combustion efficiency, all the fuel would be combusted homogenously producing only water and carbon dioxide. In practice this is a ‘chain’ reaction initiated by a spark (spark ignition engine) or heat generated with compression (compression ignition engine) which may require the aid of a ‘glowplug’.

Two factors that affect the proportion of available fuel that can be burnt include:
(i) The molecular chain length of the fuel itself—the longer the chain length, the less likely it is that complete combustion will occur in a given time frame;
(ii) The dimensions of the cylinder—the larger the volume, the longer it will take for the “flame front” to reach the boundaries of the cylinder, which for large dimensions or slow “flame fronts” may never occur.

The amount of fuel and time for combustion is limited according to engine load and piston speed (RPM) within an enclosed cylinder resulting in ‘hot’ and ‘cold’ regions for the chain reaction to progress, particularly around the cooled cylinder walls. In regions where there is no hydrocarbon for the oxygen to react, the oxygen may react with nitrogen to produce NOX. In areas deficient of oxygen incomplete combustion will occur resulting in CO. In ‘cool’ areas where the chain reaction has stopped there will be un-combusted fuel and air entering the exhaust phase. Similarly this also applies to rotary engines such as ‘Wankel’ and turbine engines. For a turbine the combustion time is limited between fuel ignition at the first expander stage and the time for the fluids to exit the last expander stage. The best case for combustion efficiency would be for example, if pure hydrogen were combusted with oxygen alone. The worst case is where the fuel has long chain molecules combusted in air which is predominantly composed of nitrogen.

Hydrocarbon fuels such as diesel have a molecular structure which is long, complex and slow to combust. These long hydrocarbons have a tendency to tangle and/or accumulate together, preventing efficient mixing of the fuel with the air or oxygen. The diesel fuel, being burnt in an enclosed chamber that is externally cooled, will ignite towards the centre of the chamber and the burn will progress outward at a slow rate. In the case of diesel engines this is largely responsible for smoke and particulate matter issuing from the exhaust system of the engine.

The object of the present invention is to ensure a more complete burn of the hydrocarbon fuel by introducing a precise amount of a secondary higher octane fuel as an additive to act as an accelerant for the combustion within the combustion chamber. The anti-knock properties of the fuel additive allow the engine to adjust the injection timing which gives an ‘Atkinson cycle’ effect for the power stroke and thus more time to combust the long chain molecules of the primary lower octane fuel. This results in increased energy transfer and enabling a reduction in fuel consumption; it improves the efficiency of an engine whereby better fuel economy is available while at the same time improving the emissions standard of the engine.

Typically, a conventional diesel engine on a heavy commercial vehicle has an effective diesel burn of between 75% and 90% of its total capability and the object of the present invention is to increase this to a level much closer to 100%.

Liquefied Petroleum Gas (LPG) and Petrol are two such readily available high octane fuels that can be used as an additive or secondary fuel(s) in order to improve the combustion of a lower octane primary fuel such as diesel.

Universally prior art has sought to maximize the quantity of LPG introduced. This might be done because gas is frequently a less expensive form of fuel. This invention is concerned with improving the combustion of the primary fuel.

U.S. Pat. No. 4,463,734 discloses a diesel engine in which increasing proportions of LPG are metered to the engine as power demand increases, starting from as little as 20% gas and increasing to about 80% gas, where the percentage is given in calorific value. By volume, the calorific value of LPG is about 60% that of diesel so that, in terms of liquid volume, the percentage range is between 30% and 87% of gas;

U.S. Pat. No. 4,641,625 discloses a range of gaseous fuel in a liquid gas mixture of between 0 and 95% gas;

U.S. Pat. No. 6,026,787 and US-A-2005/0205021 both disclose dual fuel engines, but without specifying the proportions of the fuels. The former document discloses an engine system for dual fuel has the OEM injector lines from the vehicle control module supplied to a processor which chops the pulse length to reduce the quantity of diesel injected. However, the gas is controlled by engine vacuum. The latter discloses independent control of the gas injection by a Flow Control Unit that is controlled by an integrated control unit that takes all parameters into account and determines the appropriate proportion of gas to diesel. As an integrated system it is not easily fitted as a bolt-on system to an existing vehicle.

EP1281850 discloses a controller that determines pulse widths and timings for engine injectors, which pulse width and timings are used for either diesel or gas. Separate algorithms are used to control the diesel injection and to control the gas injection.

GB2009/050261 and US2008/0098995 both disclose combustion enhancement by ‘cracking’ the primary fuel. The gas is broken down into smaller components which act as radicals then combine with the hydrocarbon chains of the primary fuel injected into the chamber, and break them up in doing so (crack), causing a chemical chain reaction throughout the chamber which results in a more homogeneous fuel/air mix. Accordingly, the efficiency of the engine is enhanced by the catalytic cracking of the long chains by hydrogen radicals. The cracking process would require energy input to the system (dissociation energy of the long chain molecules) and to have any effect would have to fully ‘crack’ the majority of the long chain molecules within a very short time (less than a millisecond) after the diesel is injected. The effect of combustion enhancement by this process is therefore limited, particularly for engines using direct injection systems.

In the present invention, precise quantities of a secondary high octane-rated fuel are introduced as a fuel additive. Such additive fuels include, but are not limited to: liquefied petroleum gas (LPG), natural gas in CNG or LNG form, methane, hydrogen; and may comprise two or more different fuels of different molecular structures. In particular, although this invention relates to gas injection of the additive fuel, a liquid injection system may be considered for certain additive fuels such as alcohols and/or petrol.

According to a first aspect of the present invention, there is provided a method of improving the fuel efficiency of an internal combustion engine, comprising the steps of measuring the quantity of a primary fuel having a lower octane rating injected into a combustion chamber of the engine during a combustion cycle, and supplying to the combustion chamber prior to combustion a controlled proportional quantity of a second or additive fuel or fuels of a higher octane rating. In the general case low octane fuel is characterised by long chain hydrocarbon molecules (such as diesel fuel) and high octane fuel by short chain length molecules (such as hydrogen). The amount by mass of the additive fuel injected is typically a proportion lying between a ‘lower threshold value’ corresponding to a relative proportion of the second fuel that is just sufficient to significantly improve the flame front speed, and an ‘upper threshold value’ corresponding to a relative proportion whereby the oxygen in the air available for combustion of the first fuel is depleted beyond such a point that the addition of a higher proportion of the additive fuel decreases the overall efficiency of the engine. Also an engine designed to combust a primary fuel may not be designed to burn the second additive fuel as efficiently; e.g. an engine designed to combust petrol will not be as efficient when fuelled by large quantities or solely using LPG. Only a small amount of additive is needed to improve the combustion of the primary fuel and this is also dependant on the engine load and speed. The flame front velocity is higher for shorter length molecules and this increases the overall flame front velocity for the dual fuel overall thus accelerating the combustion process of the combined fuels. The combustion is faster, allowing more time for combustion even in the ‘cold’ regions during the power stroke. Much (if not all) the fuel which would normally remain un-burnt and pass to the exhaust without additive high octane fuel injection would be burnt during the power stroke with high octane fuel injection. The hydrocarbon (HC) and particulate matter emissions are significantly reduced. Accordingly, the combustion efficiency of the engine is improved because more of the available fuel for combustion is combusted during the power stroke.

According to a second aspect of the present invention where a controlled proportional quantity of a second fuel or fuels is injected .prior to and/or with the primary fuel injection: A common property for the short chained molecules including hydrogen is they have a high Research Octane Number. Although hydrogen (RON>130) does not fit well into the normal definitions of octane number, it has low knock resistance in practice due to its low ignition energy (primarily due to its low dissociation energy) and extremely high flame speed. These traits are highly desirable in rocket engines, but undesirable in Otto cycle engines. However, as a second fuel hydrogen raises overall knock resistance as do the other secondary fuels for example; methane (RON 120), methanol/ethanol (RON 109), ethane (RON 108), propane/butane (RON 112). The anti-knock properties of the combined fuel are increased. The higher octane number of the combined fuel, the more compression this fuel can withstand before detonating. Accordingly, the engine efficiency is improved because fuels with a higher octane rating can be used in high-compression Otto cycle engines that generally have better performance both in terms of power and economy.

According to a third aspect of the present invention where a controlled proportional quantity of a second fuel or fuels is injected prior to and/or with the primary fuel injection: For Otto cycle engines equipped with a knock sensor the engine control unit (ECU) will retard the ignition timing when detonation is detected. Retarding the ignition timing reduces the tendency of the fuel-air mixture to detonate, but also reduces power output and fuel efficiency because the power stroke is effectively shortened. However the anti-knock properties of the combined fuel are increased and allow the ignition timing to be further advanced thus allowing more time for combustion and effectively extending the power stroke (Atkinson Cycle effect). Accordingly, the engine efficiency is improved because when fuels with a higher octane rating are used the ignition timing can be further advanced providing better performance both in terms of power and economy.

According to a forth aspect of the present invention where a controlled proportional quantity of a second fuel or fuels is injected prior to and/or with the primary fuel injection: Diesel has a very low octane (RON 20) and is more typically described by the Cetane number which reflects the fuels ability to auto-ignite, which is considered to be a desirable feature in compression ignition engines. However, for Diesel cycle engines equipped with a knock sensor the engine control unit (ECU) will retard the diesel injection timing when detonation is detected. For these engines the ignition is controlled by an engine ECU using a high pressure injection system where the primary fuel is directly injected into the cylinder at the end of the compression stroke. The injection typically is in a series of short pulses timed to minimise or eliminate engine knock and to maximise the combustion time for the power stroke. The anti-knock properties of the combined fuel are significantly increased and allow the injection timing to be significantly advanced thus allowing more time for combustion and effectively extending the power stroke (Atkinson Cycle effect). The initial auto-ignition of the primary fuel into the chamber containing a non-stoichometric amount of compressed secondary fuel and air is not affected. Accordingly, the engine efficiency is improved because when fuels with a higher octane rating are used the injection timing can be further advanced providing better performance both in terms of power and economy.

In a diesel engine, the engine is set up for burning diesel fuel using a high compression ratio to allow auto-ignition of the diesel fuel and is therefore not designed to combust lighter LPG or other small molecule fuels alone. At any given engine speed and load, the engine is typically designed to aspirate (boosted or otherwise) more air than is needed to burn the diesel injected. The gas, in burning quickly, uses much of the available oxygen, which might in any event be diminished by introducing gas into the combustion chamber. A proportion of this air is depleted by gas injection, and the gas uses a proportion of the oxygen in its own combustion, the available oxygen for combustion of the diesel will be depleted. Also a diesel engine will not combust the larger quantities of secondary high octane fuel efficiently because the compression ratio is not optimised for the efficient combustion of the secondary high octane fuel. By increasing the quantity of gas injected beyond a certain point, in the case of the invention, the ‘upper threshold value’, the oxygen available for burning the diesel is diminished and therefore the improved efficiency peaks at a relatively low level of introduced gas. This peak will depend on the engine design and aspiration of the engine.

When the arrangement is provided as a bolt-on system to an existing engine, the amount of gas injected is small that the overall engine management control system is not adversely affected. The improved efficiency is seen by the management system ECU as a reduced load on the engine or improved torque output, and will automatically reduce the amount of diesel injected and not register this as an error condition. The ECU will automatically adapt to new conditions and make changes to the injection timing according to the knock sensor measurement.

Preferred embodiments of the invention shall now be described, by way of example only, with reference to the accompanying drawings in which:

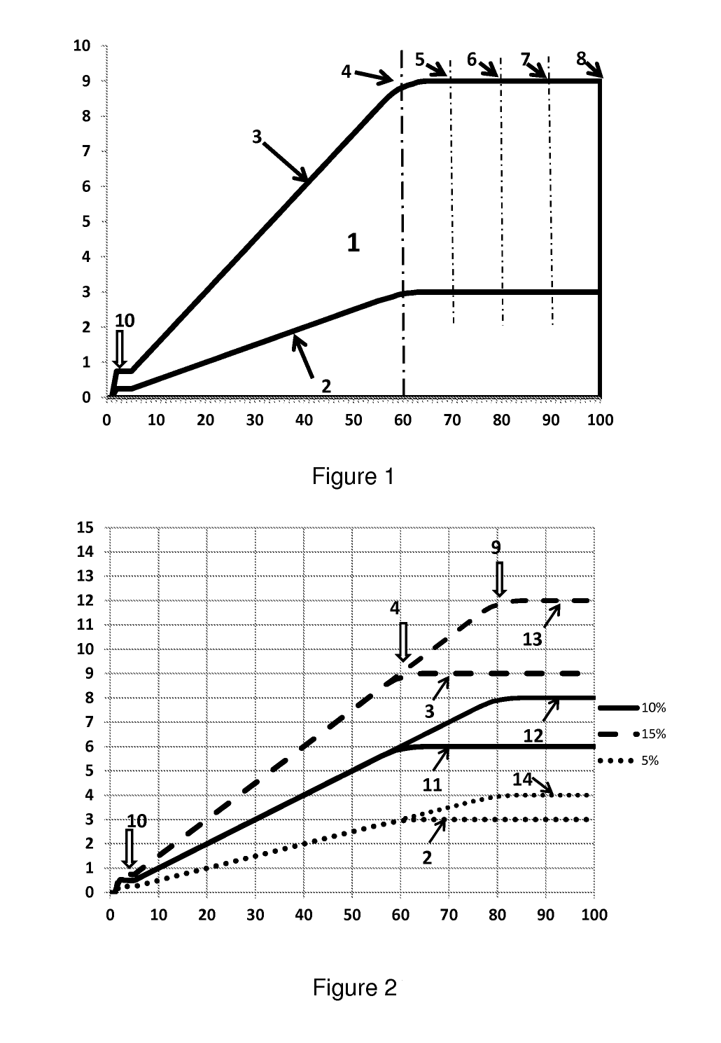

FIG. 1 is a graphical schematic which outlines the envelope for the secondary fuel injection with reduction for higher engine loads;

FIG. 2 is a graphical schematic which shows 5%, 10% and 15% by mass of the secondary fuel injection with reduction for higher engine loads;

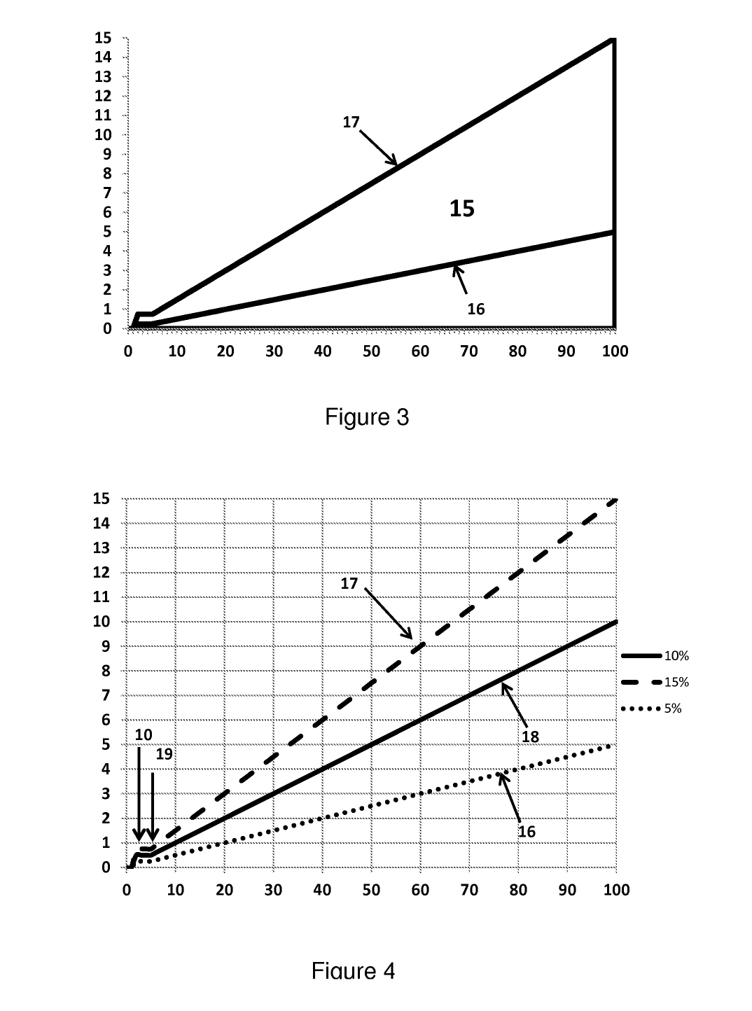

FIG. 3 is a graphical schematic which outlines the envelope for the secondary fuel injection;

FIG. 4 is a graphical schematic which shows 5%, 10% and 15% by mass of the secondary fuel injection;

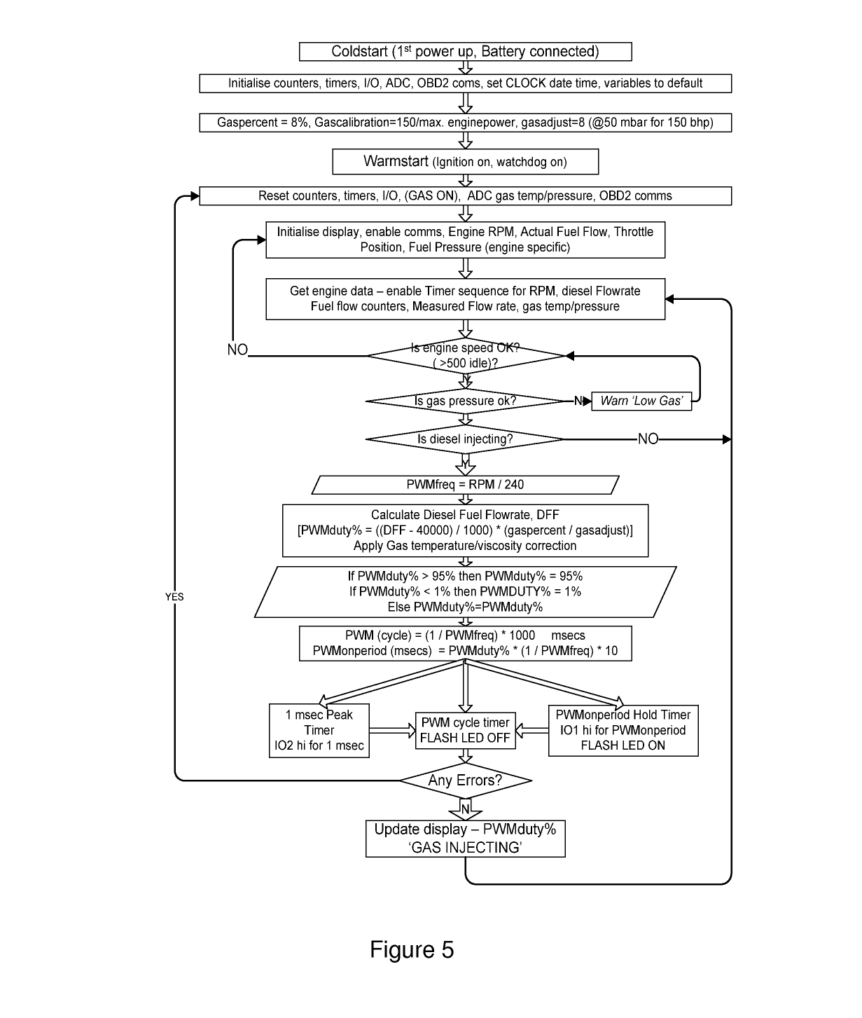

FIG. 5 is a Flow diagram for software specification;

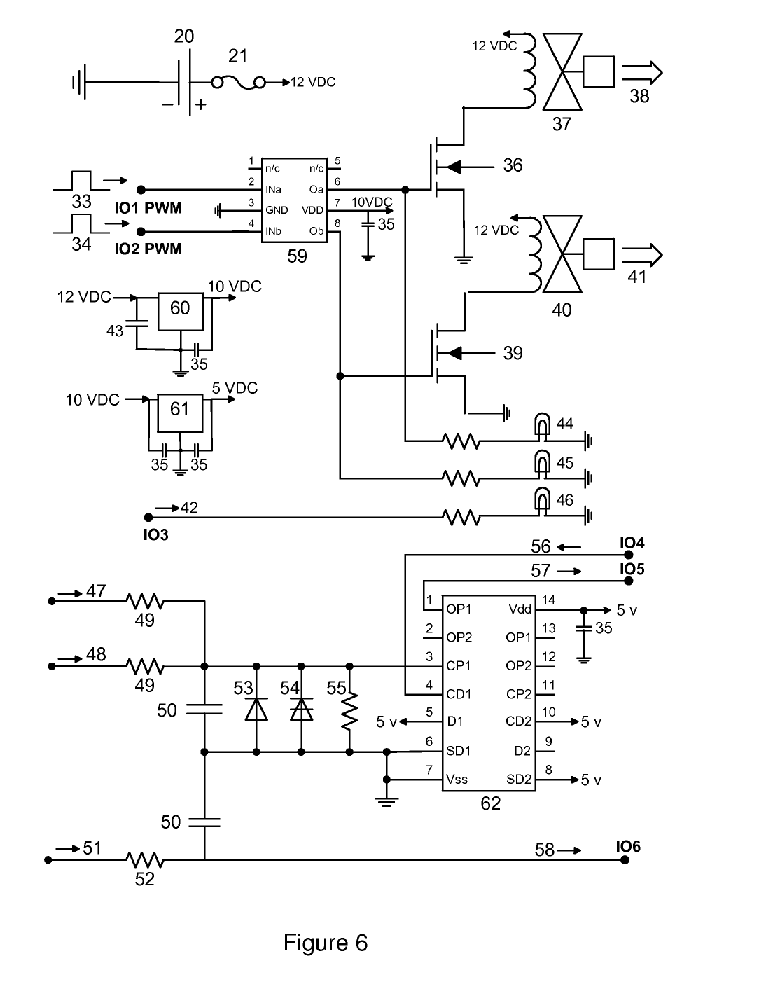

FIG. 6 is a block diagram schematic for the gas injector circuit.

The quantity of the first fuel injected into the combustion chamber may be determined by a sensor which informs a microprocessor, which calculates the quantity of the second fuel injected thereof into the combustion chamber. The secondary fuel system is an injector or injection system which applies the secondary fuel injector pulse(s) in an appropriate timing pattern.

The quantity of the first fuel may be determined by:
(i.) Measuring the supply of the first fuel by means of an inline fuel meter (and return). A similar inline fuel meter on the second fuel may allow the microprocessor to monitor and calibrate accurately the second fuel delivery. This is achieved by reading by means of a fuel flow meter, which may be mechanical or electronic in operation for both the primary fuel supply and the secondary fuel supply.
(ii.) Reading existing sensors on the engine including, but not limited to; common rail pressure sensor, Mass Air Pressure (MAP) sensor, Mass Air Flow (MAF) sensor. Diesel Injector signal(s), turbo boost pressure, throttle position (load input command), engine temperatures, air temperature. Any one or more of these signals can be used to calculate the quantity of the first fuel.
(iii.) In relation to a modern diesel engine, this may be achieved by measuring the pressure within a common rail diesel fuel supply system. When the engine is not accelerated/decelerated harshly this can provide sufficient information about the primary fuel usage to allow a calculated amount of secondary additive fuel to be introduced that sufficiently improves the combustion.
(iv.) Communication with the engine ECU. In relation to the modern diesel engine, this is achieved by taking either the fuel pressure reading or the fuel usage information directly from the vehicles onboard vehicles diagnostics (OBD) or by other communication gateways such as J1939 (for HGV), the aforementioned fuelling information, from the Electronic Engine Management System. In listen only mode, such information is available at the behest of the original equipment manufacturer.

Introduction of the second fuel may be by direct injection into the combustion chamber, during the induction stroke, compression stroke or combustion stroke of the engine. Preferably said injection is into the air intake prior to the turbocharger for maximum safety and optimum second fuel/air mix. The amount injected is determined on the basis of the amount of first fuel injected in a preceding combustion cycle of the engine (FIGS. 1-4) where the X axis represents the engine load and the Y axis represents the percentage by mass of the secondary higher octane fuel injected.

FIG. 1 defines the envelope (1) for the secondary fuel injection for engines that are slow speed (RPM) and high torque as used typically in heavy goods vehicles (HGV) busses/coaches and rail. The X axis is the mass of primary fuel expressed as a percentage of full load and the Y axis is the percentage of secondary fuel injected as a percentage of the primary fuel. The minimum edge [Minimum Fraction] of the envelope (2) is where significant enhancement of combustion begins, typically at 5% by mass secondary fuel injection. The maximum edge [Maximum Fraction] of the envelope (3), typically 15% by mass, is where the inefficiency of combusting a secondary fuel (for an engine designed to combust primary fuel) significantly counters the enhancement effects therefore resulting in no gain in the overall combustion efficiency. Point (10) represents the fuel flows at engine idle speed. At higher engine loads (4) the secondary fuel percentage is reduced because (i) there is less oxygen available and (ii) the engine performs within the design engine load limits for high load conditions. For example, FIG. 1 shows a decrease in percentage mass secondary fuel injection beyond 60% load of the engine, i.e. the 15% profile (3) is reduced to 13.5% at point (5), 12% at point (6), 10.5% at point (7) and 9% at point (8).

The solid lines (11, 12) in FIG. 2 show a more typical profile where maximum combustion efficiency occurs to produce the minimum of harmful emissions. Profile (11) shows a decreasing percentage injection above 60% (4) full load and profile (12) at 80% (9) load. The point at which the decrease begins is determined by the duty cycle of the engine; in practice, for a HGV, this would be typically set at just above the engine load for a cruising fully laden vehicle. Dashed line (13) and dotted line (14) are the 15% and 5% secondary fuel injection percentages respectively.

FIG. 3 defines the envelope (15) for the secondary fuel injection for smaller engines that are used typically in modern motor cars and vans. The injection system for these engines offer more control for the primary fuel delivery and use ‘multiburst’ (separate rapid firing of injectors) combined with a greater range for the common rail injection pressure. Thus the secondary fuel percentage may be made proportional to the primary fuel mass over the full load range of the engine (16, 17).

The solid line (18) in FIG. 4 shows a more typical profile where maximum combustion efficiency occurs to produce the minimum of harmful emissions. The optimum secondary fuel percentage depends on the engine design; bore/stroke, shape of piston/cylinder head, valve configuration, aspiration system and fuel grade, and will also vary with engine load and speed.

For low engine loads a higher percentage of secondary fuel may be used for further fuel cost savings without detriment in engine emissions (10, 19) in FIG. 4. For example, when the engine is at idle or under part-load such as when ‘power take off’ is used. For high engine loads a lower percentage of secondary additive fuel may be used to prevent engine damage due to higher temperatures incurred when combusting both fuels.

The present invention provides a convenient method of control of gas injection in a fuel employing both gas and liquid fuel simultaneously. The system can be easily bolted onto existing engines to convert them from single liquid fuel to combined fuel use without extensive modification of the engine. The invention provides a system that enables vehicle manufacturers (and other engine suppliers) relatively straightforwardly to modify their existing engines without the necessity to re-map of the engine management system. The primary fuel supply is not interrupted and/or modified; a measurement of the primary fuel flow is all that the system needs in order to control the supply of the second fuel. Existing bolt-on LPG or other gaseous fuel conversion kit can be added to a vehicle in a known manner. In this way the control function of an engine management system (EMS) is not affected and remains in full control of the engine; there are no software modifications or re-mapping required for the EMS. A modern EMS will adapt to the new engine fuelling automatically; e.g. for engines fitted with a ‘knock’ sensor the EMS may advance the injection timing for the new fuelling because of the improved RON of the duel fuel. However, since the required signal data is hardwired to the EMS the ideal configuration would be to incorporate the gas control directly from the EMS.

FIG. 5 is a flow diagram and provides an example software specification for the gas injector control of a common rail diesel engine. In this example diesel injector signals are used to calculate engine speed and facilitate gas injection timing, fuel pressure is used to calculate the diesel fuel flowrate. A hardwired ‘watchdog’ is used to continuously monitor the processor allowing gas injection when functioning correctly. Power to the gas injection system is via a fuse from the ignition circuit; in the event of a vehicle incident (for example if the air bags inflate) this circuit is immobilised and the gas system shut down.

In this example the diesel injector signal is used to calculate the timing for the gas injector(s), however other crankshaft position/velocity sensors may be used. The diesel injector signal is primarily used to determine when the gas injectors are active; for example when a vehicle is decelerating or going downhill, when there is no load demand, the EMS may de-activate the diesel injectors to conserve fuel; henceforth the gas injectors are also de-activated; i.e. gas is only injected when diesel is injected. The On Board Diagnostics (OBDII) communications is used for vehicle identification and security. However, where an EMS can output all the relevant data (for example OBD or J1939 gateways) at least twice within the time for a single piston stroke then it may be possible to use this information for the gas control algorithm.

For engines which utilise an ‘Atkinson Cycle’ effect by varying the valve timing and phase during an engine cycle it may be desirable to inject the gas as close to the inlet valve(s) as possible using an injector for each cylinder hereby referred to as sequential timed gas (or gas in liquid phase) injection. The gas is injected when the inlet valve is open and the exhaust valve is closed. This may result in a delay after the inlet valve is first opened during the induction stroke, until the exhaust valve is closed; at which point the gas can be injected without passing directly into the exhaust. Thus the gas injection cycle begins on an induction stroke where the inlet valve(s) is open and the exhaust valve(s) is closed and ends when both inlet and exhaust valves are closed. In the preferred embodiment of the invention a predictive adaptive control strategy is used to calculate the gas injection cycle using the diesel injector signals suitably conditioned. The time is measured between the prior two diesel injections according to the engine firing order and thus the current diesel injector firing and timing of the gas injection cycle can be calculated, taking into account the time for the gas to enter the combustion chamber from the gas injector.

FIG. 6 is an example schematic circuit diagram for a peak/hold gas injector (28) using standard Input/Output (10) logic from a microprocessor or PIC where:
IO1 DIGITAL OUTPUT used to drive gas/liquid injector
IO2 DIGITAL OUTPUT used to drive gas/liquid injector
IO3 DIGITAL OUTPUT used to activate gas tank/vaporiser solenoids

The circuit is powered from the vehicle battery (20) via the ignition circuit and protected with fuse (21). The hold current and peak current are switched separately using solid state switches (24, 25) activated by 101 and 102 (22,23) signals from the processor. The hold current is limited to the injector by a power resistor (26) and excess heat dissipates using heat sinks (27). Initially both switches (24,25) are turned on to activate solenoid (28). Once the solenoid has activated (typically 1 msec) the peak switch (25) is turned off. The hold current is set to maintain the solenoid open for the duration of signal (22). For vehicles without automatic emergency engine shut off it may be preferable to interface the gas supply control to the processor to enable gas shut off. Signal 103 turns on switch (29) to activate relays (30, 31) for the gas tank solenoid and vaporiser solenoid respectively; hence gas is supplied when the engine runs in normal conditions and can be shut off in an emergency automatically.

FIG. 6 is an example schematic circuit diagram for two peak/hold gas injectors (37, 40) using Input/Output (10) from a microprocessor or PIC that has Pulse Width Modulation (PWM) capability where:
IO1 PWM OUTPUT used to drive gas/liquid injector 1
IO2 PWM OUTPUT used to drive gas/liquid injector 2
IO3 DIGITAL OUTPUT used for fault coding
IO4 DIGITAL OUTPUT used to set FLIPFLOP
IO5 DIGITAL INPUT used to read state of FLIPFLOP
IO6 ANALOGUE to DIGITAL (12 bit) to digitise Fuel Pressure signal

This example is used for gas injection at the air intake for engines where there is no valve timing overlap between exhaust stroke and induction stroke of the piston; i.e. the exhaust valve is closed as the intake valve is opened. At least two or more injectors are required to ensure consistent gas delivery during the induction stroke of a piston and preferably the gas injection period at least twice the period for a piston stroke for each injector. A single gas injector may be used providing there are at least sufficient injection periods within a stroke of the piston in order to deliver consistent quantities of gas for each engine cycle. However a single injector system hence would have a shorter working life and for high speed engines the short injection period required may cause non-linearity of gas delivery due to ‘water hammer’ effect in the fluid.

Referring to FIG. 6, the hold current and peak current for gas solenoids (37, 40) are controlled using PWM signals (33, 34), input to a dual MOSFET driver (59) which switches MOSFET's (36, 39) to activate the gas solenoids and provide gas injection (38, 41). Initially the PWM signal has a 100% ‘on’ duty cycle to activate a solenoid. Once the solenoid has activated (typically 1 msec) the duty cycle is adjusted to supply an average hold current for a given solenoid for the duration of the gas injection period. Hence it is possible, using software changes only, to drive different types of gas or liquid injector without making hardware changes to the gas injection circuit. A 10 volt regulator (60) is used to supply the preferred voltage for the MOSFET driver (59). In this example the gas injection signals are displayed using orange LED's (44, 45). A further green LED (46) is used to indicate correct operation of the gas injection system via a ‘watchdog’ (103) and may be used to signal ‘trouble’ codes such as for example, low gas pressure'.

Signals (47, 48) are the engine diesel injector signals, in this circuit they are used to indicate actual fuel injection for the engine. For an engine with a large number of cylinders two or more (or all) diesel injector signals may be monitored. The diesel injector signals are interfaced using high value resistors (49) typically above 100 Kohm and further signal conditioned using RC filter (55, 50), voltage limiting Zener diode (54) and signal conditioning diode (53) to block back e.m.f. caused by the diesel injector solenoid. After signal conditioning the diesel injector pulses can be connected as logic inputs via a Schmitt trigger logic gate. Said inputs can be connected to counter/timer 10 for engine speed calculation and/or to calculate sequential timed gas injection as described above. In this example this signal is connected to a ‘D’ type flip flop (62) which has Schmitt inputs. The flip flop is set by 104 (56) by the processor during every gas cycle which sets the output (57) of the flip flop low 105. The diesel injector signal resets the flip flop and output goes high which indicates the diesel injectors are firing and engine is using fuel. Thus the processor uses the 105 input to enable gas injection only when diesel injection is activated by the EMS.

Signal (51) is an analogue common rail fuel pressure signal, in this circuit it is used to determine the fuel flow rate for the engine. 106 is high impedance (>1 Mohm) buffered analogue to digital (12 bit ADC) input to the processor. The fuel pressure signal is conditioned using a low pass RC filter (52, 50) with input resistor (52) of sufficiently high value (640 Kohm) not to alter the measured voltage from the fuel pressure sensor. Further analogue signals may be required in order to determine the fuel flow rate using additional analogue inputs to the processor.

The improved thermal efficiency within the internal combustion engine afforded by adding the secondary fuel will provide improved output in terms of power, torque and energy, while using less overall fuel and producing considerably less harmful emissions, particularly nitrogen oxides, as well as, in the case of diesel fuel, a considerable reduction in particulate matter and smoke. In the case of a truck engine, for example, this improvement in efficiency is interpreted by the engine's PCM as though it were a reduction in load carried by the vehicle, so the PCM will consequently retard the quantity of diesel fuel supplied and thus improve the economy of the engine in direct proportion to the improvement in engine efficiency.

Typical results on a HGV diesel engines show a reduction in primary fuel consumption of around 20%, using only 5% to 15% of secondary additive fuel (LPG) to achieve this improvement. The amount of secondary fuel depends on the engine speed and load conditions, and to a lesser extent on the primary diesel fuel grade and content of the LPG added. LPG is a mixture of Butane and Propane which varies between suppliers. These improvements are achieved in a non-invasive manner so that the engine life and/or periods between servicing will be extended due to the reduction in carbon deposits. The heavier the primary fuel, the greater is the improvement in engine efficiency and reduction in exhaust emissions. Similarly a larger and older engines having significant ‘coking’ of the engine would also show even better improvements in combustion efficiency.

1. A method of improving the fuel efficiency and reduce emissions of a compression ignition internal combustion engine, comprising the steps of measuring the quantity of a first fuel having a lower octane rating injected into a combustion chamber of the engine during a combustion cycle, supplying to the combustion chamber a controlled proportional quantity of a second additive fuel having a higher octane rating, the second fuel or fuels injected prior to and/or with the primary fuel injection, wherein the combined fuel properties improve engine ‘knock’ to provide an ‘Atkinson Cycle’ effect by modifying the timing of the primary fuel injection pulses, the gas injection system powered from an electrical power source, wherein the system comprises electronics to process first fuel flow signal(s) to calculate the quantity of the first fuel injected and provide control signal output(s) for second fuel injector(s) to inject a proportional quantity of second additive fuel, whereby the amount by calorific value of the second fuel injected is controlled to a Maximum Fraction of 15% whereupon the inefficiency of combusting the second additive fuel significantly counters the improvement made by introducing the higher octane rating additive to the first fuel.

2-6. (canceled)

7. A method according to claim 1 wherein the quantity of the first fuel is measured by any means and informs a microprocessor which controls the proportional quantity of the second additive fuel being injected directly and/or indirectly into the combustion chamber at a subsequent point in time coincident with an induction, compression or combustion stroke of the engine.

8. A method according any preceding claims wherein said injection of the second additive fuel is into an inlet intake of the engine during the induction stroke of any chamber and is determined on the basis of the amount of first fuel injected in a preceding combustion cycle of the engine, preferably an immediately preceding cycle and wherein injection into said inlet intake begins after all outlet valves of the chamber in question have closed in or following the preceding exhaust stroke of the engine and before the inlet valve of the chamber in question closes in or following said induction stroke of the engine.

9-11. (canceled)

12. A system according to any preceding claim, wherein the quantity of the first fuel is determined by:
(i.) measurement of the supply of air to the engine by using a mass airflow sensor and/or a manifold air pressure sensor and/or in conjunction with a wide band exhaust sensor;
(ii.) measurement of the supply of the first fuel using electronic ultrasonic or mechanical fuel flow measuring device(s) producing analogue or digital signal(s) interfaced to a microprocessor;
(iii.) measurement of an injector open period as determined by using electronic timers;
(iv.)measurement of both the fuel pump pressure sensor signal combined with a measured injector open period;
(v.) interfacing to an engine management system which has output(s) that include primary fuel flow data for an electronically controlled fuel injected internal combustion engine comprising an engine management system.

13-21. (canceled)

22. A method according to any preceding claim, wherein the second additive fuel is liquefied petroleum gas (LPG), compressed natural gas (CNG), liquid natural gas (LNG), methane, hydrogen, (Browns gas), petrol or hydrocarbon having a higher octane rating than diesel or wherein the second additive fuel comprises two or more different fuels of different molecular structures.

22-25. (canceled)

26. Any internal combustion engine to put the method of claims 1 to 25 into effect comprising: means to measure the quantity of a first diesel fuel having a low octane rating injected into a combustion chamber of the engine during a combustion cycle;
means to supply to the combustion chamber a controlled proportional quantity of a second additive fuel of a higher octane rating; and means controlling the amount by calorific value of the second additive fuel injected to the Maximum Fraction of 15% of the first fuel.
